(19) United States
(12) Patent Application Publication
(10) Pub. No.: US 2025/0089014 A1
(43) Pub. Date: Mar. 13, 2025

(54) WIRELESS SENSING

(71) Applicant: Cypress Semiconductor Corporation, San Jose, CA (US)

(72) Inventors: Niall Lyons, Irvine, CA (US); Avik Santra, Irvine, CA (US); Kiran Uln, Pleasanton, CA (US); Rakesh Taori, McKinney, TX (US); Vikram Kumar Ramanna, San Jose, CA (US); Ashutosh Pandey, Irvine, CA (US)

(73) Assignee: Cypress Semiconductor Corporation, San Jose, CA (US)

(21) Appl. No.: 18/424,442

(22) Filed: Jan. 26, 2024

Related U.S. Application Data
(60) Provisional application No. 63/538,218, filed on Sep. 13, 2023.

(51) Int. Cl. H04W 64/00; H04B 7/06; H04B 17/391

(52) U.S. Cl. CPC H04W 64/006; H04B 7/0626; H04B 17/3913

(57) ABSTRACT

The present disclosure provides an approach that captures one or more wireless signals in a geographic area. Each one of the one or more wireless signals includes channel state information (CSI) data. The present disclosure produces a channel state information (CSI) representation based on the CSI data that indicates multiple channel responses corresponding to the one or more wireless signals. The present disclosure filters the CSI representation to remove at least one of the channel responses that correspond to a stationary object within the geographic area to produce a filtered CSI representation. The present disclosure predicts a presence of a moving object within the geographic area based on the filtered CSI representation.

### CROSS-REFERENCE TO RELATED APPLICATIONS

This application claims priority from and the benefit of U.S. Provisional Patent Application No. 63/538,218, filed Sep. 13, 2023, the entire contents of which are incorporated herein by reference.

### TECHNICAL FIELD

Aspects of the present disclosure relate to wireless sensing, and more particularly, to improving activity detection in wireless sensing systems.

### BACKGROUND

Wireless sensing is a technology that utilizes wireless signals to detect a presence of moving objects. As a wireless signal propagates through an area, properties of the wireless signal are affected by stationary objects (e.g., walls, furniture, etc.) and moving objects (people, pets, robots, curtains, doors, etc.). When the wireless signal encounters an object, the wireless signal may be reflected, refracted, scattered, or absorbed, depending on the object's material properties. In addition, moving objects in the area may also produce shifts in the wireless signal's frequency.

A wireless sensing receiver, such as a wireless fidelity (Wi-Fi™) receiver, identifies the changes in the wireless signal's properties and uses the identified changes to generate predictions, such as whether the area includes a presence and movement of an object (e.g., walking, sitting, opening door, etc.).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system for enhanced Wireless sensing, in accordance with some embodiments of the present disclosure.

FIG. 2 is a block diagram that illustrates an example preprocessing pipeline, in accordance with some embodiments of the present disclosure.

FIG. 3 is a block diagram that illustrates an example system for training a Bayesian CNN using contrastive data augmentation and self-supervised learning, in accordance with some embodiments of the present disclosure.

FIG. 4 is a flow diagram of a method for using wireless sensing to accurately predict human activity, in accordance with some embodiments of the present disclosure.

FIG. 5 is a block diagram of an example computing device that may perform one or more of the operations described herein, in accordance with some embodiments of the present disclosure.

### DETAILED DESCRIPTION

As discussed above, wireless sensing is a technology that uses wireless signals to detect a presence of moving objects. Wireless sensing leverages Channel State Information (CSI) data in wireless signals to sense and identify the changes in a given environment. CSI is a measure of the wireless signal's properties, reflecting how the signal propagates from a transmitter to a receiver and characterizes a combined effect of scattering, fading, and power decay with distance. In wireless sensing, CSI is used to identify variations in the wireless signal's attributes as it interacts with moving objects in its propagation path. These interactions cause the CSI values to fluctuate and provide a signature for particular events or movements. Channel frequency response (CFR) data is included in the CSI data (CFR CSI data), which provides a frequency domain representation of the wireless signal and characterizes the behavior of the wireless signal across different frequencies.

A challenge found with wireless sensing technology is that the complexity and variability of real-world environments can introduce many confounding factors into analyzing wireless signal changes, such as with multipath propagation. Multipath propagation occurs when signals bounce off walls and objects, creating a complex mix of signals at the receiver, which makes it challenging to attribute signal changes to particular causes. Another challenge found with wireless sensing is that wireless signals may be affected by stationary objects, objects that are typically stationary but that intermittently move, and electromagnetic waves, therefore making accurate detection and interpretation difficult. For example, CSI data variations may be due to RF impairments (automatic gain control (AGC) gain, packet detection delay, residual sampling frequency offset (SFO)), open windows, curtains moving, fans, air conditioning, active speakers, repositioning furniture, etc., as well as artifacts outside room boundaries.

Another challenge found with wireless sensing is the ability to obtain enough training data to properly train models for detecting a presence and activity. In an ideal scenario, training data should cover an exhaustive range of environmental conditions and variations, different types of movement, varying number and types of objects, and differing spatial layouts. However, creating such an extensive and diverse training dataset can be time-consuming, expensive, and sometimes impractical, especially to accurately label the training data. Moreover, as discussed above, wireless CSI data is highly sensitive to the environment and changes in physical layouts. Even atmospheric conditions can lead to different CSI distributions.

The present disclosure addresses the above-noted and other deficiencies by using a preprocessing pipeline and a self-supervised learning framework that trains a Bayesian Convolutional Neural Network (CNN) to improve wireless sensing. The present disclosure provides an approach that captures one or more wireless signals, which include channel state information (CSI) data, in a geographic area. The approach produces a channel state information (CSI) representation, based on the CSI data, which indicates multiple channel responses corresponding to the wireless signals. The approach then filters the CSI representation to remove at least one of the channel responses that correspond to a stationary object within the geographic area to produce a filtered CSI representation. In turn, the approach predicts a presence of a moving object within the geographic area based on the filtered CSI representation.

In some embodiments, the CSI representation is filtered using a motion target indicator (MTI) filter. The approach computes a weighted historical CSI average based on historical wireless signals that include historical CSI data received over time. The approach then subtracts the weighted historical CSI average from the CSI representation to produce the filtered CSI representation.

In some embodiments, the approach transforms the filtered CSI representation into a Doppler trace image. The approach inputs the Doppler trace image into a Bayesian CNN that is trained to detect one or more human activities. In turn, the approach, using the Bayesian CNN, produces a prediction that identifies at least one of the one or more human activities within the geographic area. For example, the Bayesian CNN may output a probability distribution over possible outcomes (no presence, major motion (walking or running), minor motion (standing or sitting), jerk motions (falling or exercising), etc.). The probability distributions quantify how certain (or uncertain) the Bayesian CNN is about its prediction. Common measures include the variance or standard deviation of the output distribution.

In some embodiments, the approach trains the Bayesian CNN in a self-supervised training mode. The approach creates an augmented Doppler trace image from the Doppler trace image that is a deformable transform of the Doppler trace image relevant to one or more physical properties of the one or more wireless signals. The approach inputs the Doppler trace image and the augmented Doppler trace image into the Bayesian CNN. The Bayesian CNN transforms the Doppler trace image and the augmented Doppler trace image into an original latent space representation and an augmented latent space representation, respectively. Then, the approach computes a contrastive loss between the original latent space representation and the augmented latent space representation, and adjusts one or more properties of the Bayesian CNN based on the contrastive loss.

In some embodiments, the approach creates the augmented Doppler trace image using at least one of random scale and noise augmentation, random puncturing and erasures augmentation, random cyclic shifts augmentation, or random time dilation and warping augmentation.

In some embodiments to train the Bayesian CNN, the approach inputs the original latent space representation and the augmented latent space representation into a probe to produce a probe classification. The probe includes both a focal loss function and an evidence lower bound (ELBO) loss function. In turn, the approach uses the probe classification and the contrastive loss to train the Bayesian CNN. In some embodiments, the probe classification includes activity logits corresponding to at least one of the human activities.

As discussed herein, the present disclosure provides an approach that improves the operation of a computer system by creating augmented Doppler trace images using contrastive data augmentations relevant to physical properties of wireless signals to train a Bayesian CNN. In addition, the present disclosure provides an improvement to the technological field of wireless sensing by including a motion target indicator (MTI) filter into a preprocessing pipeline to improve the accuracy of human activity predictions (e.g., human geofenced activity predictions).

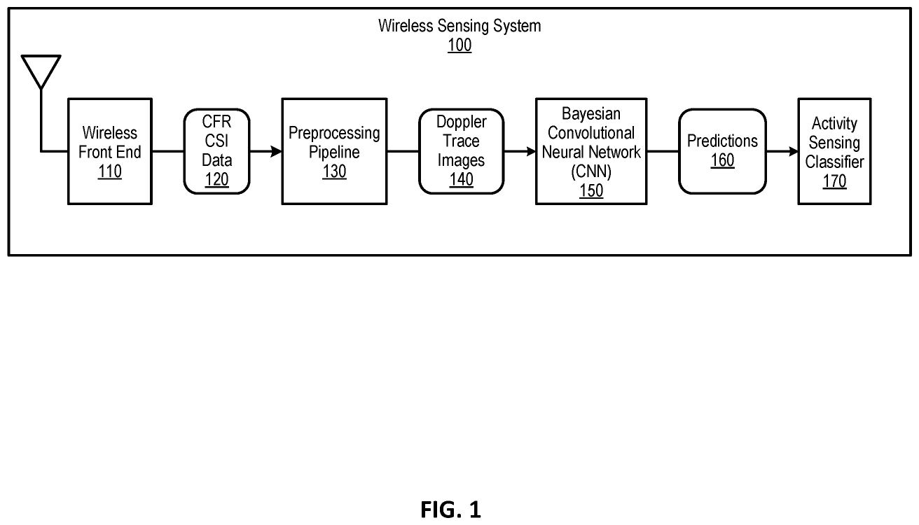

FIG. 1 is a block diagram that illustrates an example system for enhanced wireless sensing, in accordance with some embodiments of the present disclosure. Wireless sensing system 100 includes wireless front end 110, which includes, for example, an RF receiver, packet detection and symbol synchronization logic, demodulation logic, channel estimation logic, equalization logic, decode logic, and beacon frame filter logic. Wireless front end 110 receives wireless signals (e.g., transmitted from an access point, station, etc.) and outputs CFR CSI data 120 to preprocessing pipeline 130. As discussed above, the CSI data is a measure of the received wireless signal's properties and the CFR data provides a frequency domain representation of the wireless signal and characterizes the behavior of the wireless signal across different frequencies.

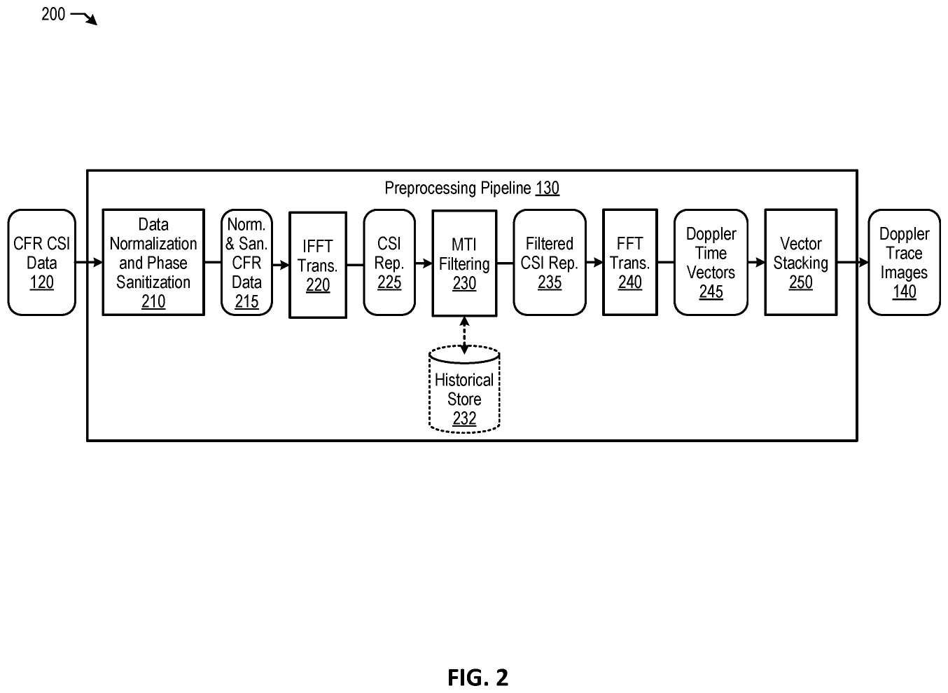

Preprocessing pipeline 130 produces CSI representations from the CFR CSI data 120 using, for example, an Inverse Fast Fourier Transform (IFFT), which corresponds to multiple channel responses of the wireless signals. Then, preprocessing pipeline 130 uses a moving target indicator (MTI) filter to remove some channel responses from the CSI representation that correspond to stationary objects and produce filtered CSI representations. In turn, preprocessing pipeline 130 produces Doppler trace images 140 based on the CSI representations. Doppler trace images 140 amplify variations in CFR CSI data 120 that are induced from human movements (see FIG. 2 and corresponding text for further details).

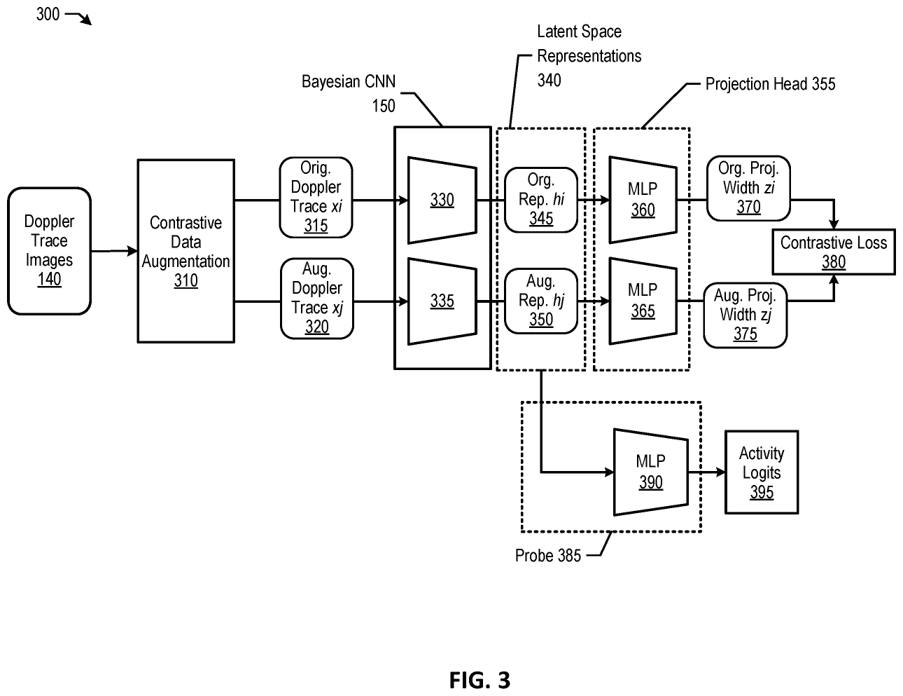

Bayesian convolutional neural network (CNN) 150 is trained to detect a presence of a moving object, and in particular to detect human geofenced activities (see FIG. 3 and corresponding text for further details). Human geofenced activity detection refers to the detection of human actions or behaviors within a defined virtual geographic boundary (e.g., a geofence). In some embodiments, Bayesian CNN 150 is trained using Doppler trace images 140 (or similar Doppler trace images) and augmented Doppler trace images, which are deformable transforms of Doppler trace images 140 relevant to physical properties of wireless signals (see FIG. 3 and corresponding text for further details).

Bayesian CNN 150 produces predictions 160 based on Doppler trace images 140. Predictions 160 include probability distributions over possible outcomes (no presence, major motion (walking or running), minor motion (standing or sitting), jerk motion (falling or exercising), etc.). In turn, activity sensing classifier 170 classifies a human activity based on predictions 160. For example, predictions 160 may include [0.1 no presence; 0.3 minor motion; 0.6 major motion], and activity sensing classifier 170 assigns a major motion classification to the corresponding Doppler trace images 140.

FIG. 2 is a block diagram that illustrates an example preprocessing pipeline, in accordance with some embodiments of the present disclosure. Diagram 200 shows preprocessing Use Gap Code pipeline 130, which receives CFR CSI data 120 from wireless front end 110. In some embodiments, preprocessing pipeline 130 extracts the CFR data from CFR CSI data 120. In some embodiments, the CFR data is collected along N=64 subcarriers across time T index/packets at an interval of 100 ms (X[1:N,1:T]).

Data normalization and phase sanitization 210 normalizes the CFR data across time T to adjust for changes in receiver automatic gain control (AGC), non-linear variations due to RF sub-systems, or a combination thereof. Data normalization and phase sanitization 210 also removes phase drifts due to packet detection delays and sampling offsets. In some embodiments, data normalization and phase sanitization 210 performs polynomial fitting on the phase component of the CFR data as a polynomial function and subtracts the polynomial from the raw phase to remove systematic phase error. In some embodiments, the polynomial fitting model is defined as

$$ϕ ( f ) = \text{?} {a}_{i} {f}^{i} , \qquad ( 1 )$$

$$\text{?} \text{indicates text missing or illegible when filed}$$

where “a” and “f” represent coefficients and the frequency variable of the polynomial model, respectively, and I=2, and is used to capture the systematic phase error. The phase of CFR CSI data 120 is modeled as a polynomial function of the frequency, denoted by ϕ(f). This model is used to approximate the systematic errors in the phase data. The terms aᵢ in the polynomial expression represent the coefficients that are determined during the fitting process. These coefficients are the factors by which each corresponding power of the frequency variable (f) is scaled and define the shape and the slope of the polynomial used to correct the phase errors. In turn, data normalization and phase sanitization 210 produces normalized and sanitized CFR data 215.

IFFT (Inverse Fast Fourier Transform) 220 transforms normalized and sanitized CFR data 215 into CSI representations 225 (e.g., \tilde{X}[1:Nd,1:T]) by applying an IFFT, for example, along subcarrier dimensions. The CSI representations 225 amplify transient properties intrinsic to CSI data for enhanced Doppler profiling used in subsequent processing steps (discussed below). In some embodiments, CSI representation 225 is channel impulse response (CIR) data.

Moving target indicator (MTI) filtering 230 removes channel responses from the CSI representations 225 corresponding to stationary objects (e.g. walls, furniture, etc.) within a room to produce filtered CSI representations 235. In some embodiments, to remove the unwanted channel responses, MTI filtering 230 builds statistics of CSI data over time (stored in historical store 232) and applies weightings to the historical CSI data to compute a weighted historical CSI average. Then, MTI filtering 230 subtracts the weighted historical CSI average from incoming signals to remove channel responses from the stationary objects. In some embodiments, MTI filtering 230 applies less weighting to older CSI data by employing an exponential moving average M[1:N,1] with a forgetting factor (e.g., η=0.985) along a temporal dimension. MTI filtering 230 then computes the filtered CSI representations Z_{[1:N,t]} as

$${Z}_{[ 1 : Nd , t ]} = {\tilde{X}}_{[ 1 : Nd , t ]} - {M}_{[ 1 : Nd , t - 1 ]} , \qquad ( 2 )$$

where M_{[1:Nd,t-1]} is updated recursively as

$${M}_{[ 1 : Nd , t ]} = η {M}_{[ 1 : Nd , t - 1 ]} + ( 1 - η ) {\tilde{X}}_{[ 1 : Nd , t ]} . \qquad ( 3 )$$

In some embodiments, when MTI filtering 230 isolates instantaneous variations in the CSI representations 225 and attenuates stationary components, MTI filtering 230 enhances the overall sensitivity of preprocessing pipeline 130 to micro-motions (e.g., human breathing or slight movements).

FFT (Fast Fourier Transform) transformation 240 generates Doppler time vectors 245 by applying, for example, a one-dimensional (1D) FFT on filtered CSI representations 235 (Z_{[1:Nd,1:T]}) across packets a dimension T and averaging across a delay dimension Nd, thereby encapsulating the Doppler variations within a monitored window. In turn, FFT transformation 240 generates Doppler time vectors 245 for each time index by a sliding window “w” along time/packets. In some embodiments, MTI filtering 230 is performed after FFT transformation 260, in which case MTI filtering 230 performs a two-dimensional (2D) MTI filtering. In some embodiments, Doppler time vectors 245 may be fed into a time-distributed neural network such as a Long Short-Term Memory network (LSTM) or a Temporal Convolutional Neural Network (TCNN).

Vector stacking 250 stacks the Doppler time vectors 245 (\tilde{Z}_{[1:Td,w]}) column-wise to generate Doppler trace images 140 (e.g., 2D Doppler trace images). Doppler trace images 140 amplify variations in CSI data that are induced due to human movements. As discussed herein, Doppler trace images 140 are input to Bayesian CNN 150 during runtime operations, and are also used to generate contrastive data augmentation images to train Bayesian CNN 150 (see FIG. 3 and corresponding text for further details).

FIG. 3 is a block diagram that illustrates an example system for training a Bayesian CNN using contrastive data augmentation and self-supervised learning, in accordance with some embodiments of the present disclosure. System 300 includes Bayesian CNN 150, projection head 355, and probe 385. As discussed herein, Bayesian CNN 150 performs feature extraction to produce latent space representations, projection head 355 optimizes the latent space representations for contrastive learning, and probe 385 performs task classification during training. As discussed below, system 300 leverages contrastive loss 380 from projection head 355 and focal-evidence lower bound (F-ELBO) loss in probe 385 for Bayesian CNN 150 self-supervised learning.

System 300 includes contrastive data augmentation 310 that receives Doppler trace images 140 from preprocessing pipeline 130. In some embodiments, Doppler trace images 140 are “training” Doppler trace images that may be previously created by preprocessing pipeline 130 and stored in a training storage area. Contrastive data augmentation 310 applies contrastive data augmentations to Doppler trace images 140 to produce deformable transforms that are relevant to physical properties of wireless signals. Contrastive data augmentation 310 may use targeted wireless signal type augmentation techniques, such as a) random scale and noise augmentation; b) random puncturing and erasures augmentation; c) random cyclic shifts augmentation; d) random time dilation and warping augmentation; or a combination thereof. Random scaling and noise augmentation applied to Doppler trace images 140 trains Bayesian CNN 150 to be robust to noise variations in input data. In some embodiments, the random scaling factor convolves the input trace while a noise level is randomly applied to Doppler trace images 140. Random puncturing and erasures augmentation involves masking a portion of Doppler trace images 140 with zeros, which simulates missing data or occlusions in real-world scenarios and is a form of dropout applied directly to input data to train Bayesian CNN 150. Random cyclic shifts augmentation involves translating Doppler trace images 140 along a time axis, which accounts for variability in the start of a Doppler trace to train Bayesian CNN 150. Random time dilation and warping augmentation involves changing the time scale of Doppler trace images 140 to mimic variations in the wireless signal from varying motions due to object movements, aspect angles, or a person's physics characteristics to train Bayesian CNN 150.

Contrastive data augmentation 310 outputs an original Doppler trace image 315 and an augmented Doppler trace image 320, which has been augmented using one or more of the augmentation techniques discussed above. Contrastive data augmentation 310 feeds original Doppler trace image 315 and augmented Doppler trace image 320 into Bayesian CNN 150's encoders 330 and 335. Encoders 330 and 335 produce latent space representations 340, which include original latent space representation 345 (corresponding to original Doppler trace image 315) and augmented latent space representation 340 (corresponding to augmented Doppler trace image 320).

Original latent space representation 345 and augmented latent space representation 340 feed into projection head 355. Projection head 355 includes Multilayer Perceptrons (MLPs) 360 and 365, which include layers of nodes (or neurons) such as an input layer to receive the signal, an output layer that generates a decision or prediction about the input, and one or more hidden layers. Projection head 355 produces projection widths 370 and 375 (e.g., shapes of the outputs). System 300 then computes a contrastive loss function (contrastive loss 380) based on the differences and similarities of projection widths 370 and 375.

In some embodiments, the contrastive loss 380 may be a normalized temperature-controlled cross entropy (NT-Xent) loss that maximizes the mutual information between positive pairs of 370, 375, and minimizes the mutual information between negative pairs of 370, 375, and uses a temperature parameter τ to control the hardness of positive-negative sample pairs. For example, the directional NT-Xent loss may be defined as:

$${L}_{1 \to 2} = - \frac{1}{N} {\sum }_{i = 1}^{N} log ( \frac{exp ( sim \text{?} / τ )}{{\sum }_{j = 1}^{N} exp ( sim \text{?} / τ )} ) \qquad ( 4 )$$

$$\text{?} \text{indicates text missing or illegible when filed}$$

where N represents the number of data points in the batch, x+ represents the contrastive data augmented image of a positive example xi, sim(x, x′) represents the cosine similarity between data pairs, and the temperature-scaled similarities are used as logits in cross-entropy. Then, the total contrastive loss LC backpropagated through Bayesian CNN 150 and projection head 355 is represented as:

$${ℒ}_{C} = max ( \frac{1}{2} ( {L}_{1 \to 2} + {L}_{2 \to 1} ) - α , 0 ) \qquad ( 5 )$$

where LC represents the used contrastive loss to train Bayesian CNN 150 and projection head 355, L_{1→2} and L_{2→1} denote a directional NT-Xent losses between two data points, and a is a margin parameter that sets a threshold below which the distances between dissimilar points are not penalized. Directional NT-Xent loss L_{1→2} and L_{2→1} represent the directed (asymmetric) versions of the NT-Xent loss, computed from two different data points or views. L_{1→2} denotes the loss calculated by considering data point 1 as the anchor and point 2 as the positive example, while L_{2→1} denotes the loss calculated by considering data point 2 as the anchor and point 1 as the positive example. L_{1→2} and L_{2→1} are directional or asymmetric contrastive loss computations using NT-Xent that contribute to the overall contrastive loss, which are used in training Bayesian CNN 150 and projection head 355 to encourage Bayesian CNN 150 to learn representations that cluster positive pairs together and separate negative pairs and, in turn, learn generalizable and robust features from unlabeled data. As discussed below, the focal-evidence lower bound (F-ELBO) loss further refines the training by incorporating evidence from the data into the learned representations while maintaining regularization.

Probe 385 includes MLP 390 to produce activity logits 395. Activity logits 395, in some embodiments, are non-normalized output values that correspond to human activity detection. Probe 385 produces activity logits 395 using a combined F-ELBO loss that includes two terms. The first term is a likelihood term represented by focal cross-entropy loss. The second term is a regularization term, which encourages Bayesian CNN 150's parameters to remain close to their prior distribution. In some embodiments, the F-ELBO loss is represented as

$${L}_{F - ELBO} = {L}_{focal} ( {p}_{t} ) + β KL ( q ( w \vert 𝒟 ) \vert \vert p ( w ) ) \qquad ( 6 )$$

where D represents the dataset, w represents the weights of the neural network (Bayesian CNN 150), q(w|D) is the variational posterior distribution over the weights given the data, p(w) is the prior distribution over the weights, a focal cross-entropy loss is given as

$$Lfocal ( p t ) = - α {t ( 1 - p t )}^{γ} log ( p t ) \qquad ( 7 )$$

where pₜ is the predicted probability of the true class, αt is a weighting factor that assigns varying weights to different classes, beta is weighting hyperparameter, γ is a focusing parameter that controls the degree of down-weighting, and log(pₜ) represents the standard cross-entropy loss for a class t.

In some embodiments, system 300 uses a two-stage training approach. In the first stage, system 300 trains Bayesian CNN 150 using outputs from projection head 355 and probe 385. In some embodiments, an Adaptive Moment Estimation (Adam) optimizer with a learning rate (e.g., 0.001) is used in the first stage of training. In the second stage, system 300 trains Bayesian CNN 150 using outputs from probe 385 to learn geofenced activity maps with lower learning rates. In some embodiments, hyperparameter optimization is used for projection widths, batch size, and regularization terms in the F-ELBO loss.

In some embodiments, over time, Bayesian CNN 150 learns to encode similar representations for augmented views of the same data point, and different representations for different data points. Producing two traces (315 and 335) of the same data point enables Bayesian CNN 150 to understand and learn the invariant features of data points that persists across different augmentations. As such, Bayesian CNN 150 learns more robust and generalizable representations by focusing on the underlying structure of the data rather than on idiosyncrasies present in a single view.

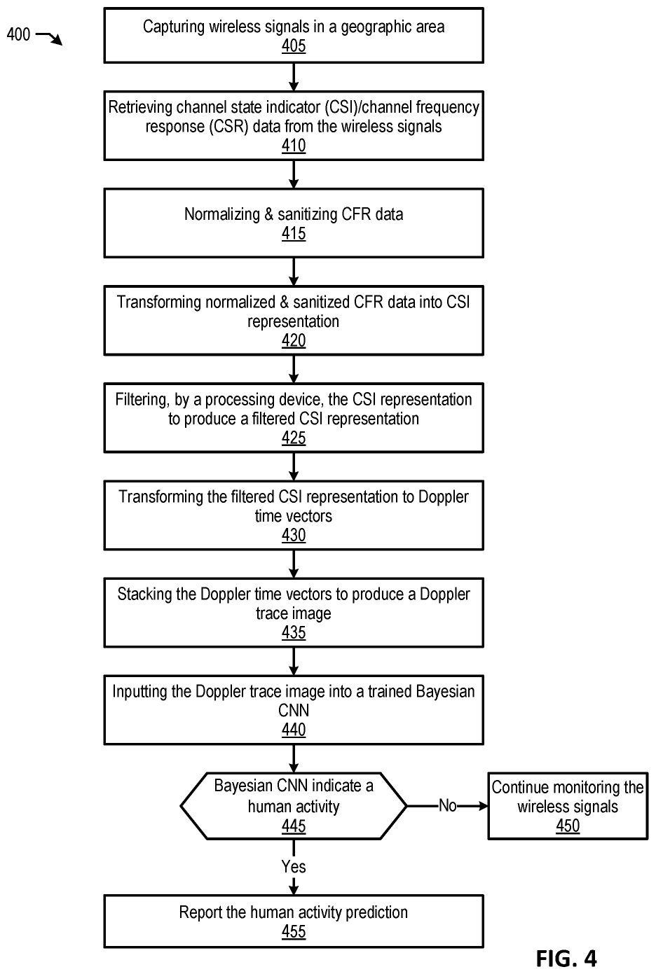

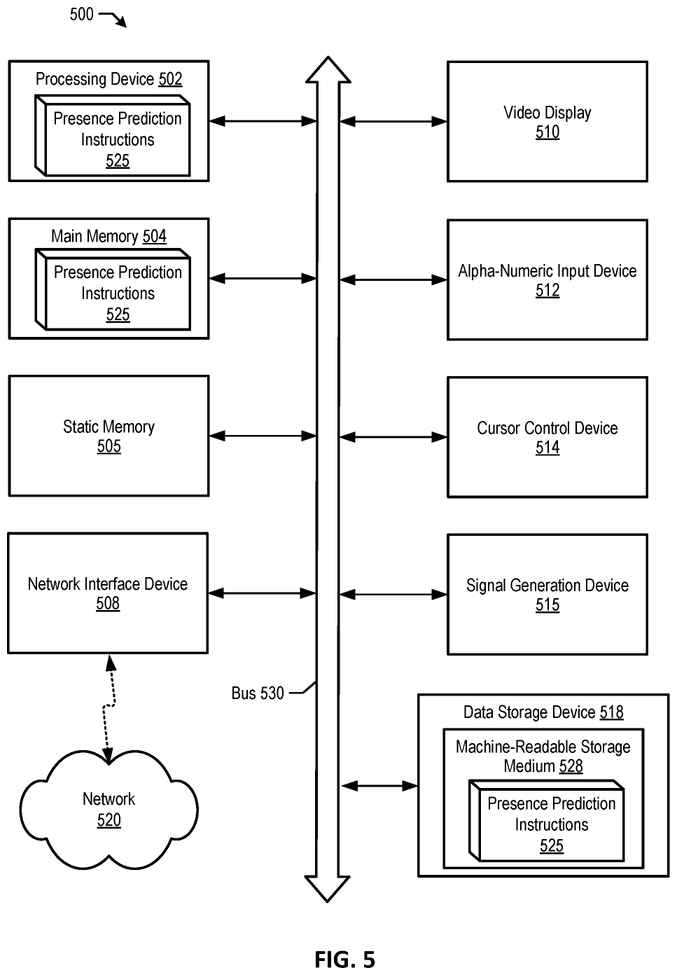

FIG. 4 is a flow diagram of a method for using wireless sensing to accurately predict human activity, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by preprocessing pipeline 130, Bayesian CNN 150, activity sensing classifier 170, processing device 502 shown in FIG. 5, or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 405, where processing logic captures one or more wireless signals in a geographic area. For example, processing logic may be part of a wireless sensing system that monitors Wi-Fi signals in an office room. At block 410, processing logic retrieves channel state information (CSI) with channel frequency response (CFR) data from the captured wireless signals. At block 415, processing logic normalizes and sanitizes the CFR data to produce normalized and sanitized CFR data. At block 420, processing logic transforms the normalized and sanitized CFR data into a CSI representation. The CSI representation indicates multiple channel responses corresponding to the wireless signals.

At block 425, processing logic filters the CSI representation to produce a filtered CSI representation. In some embodiments, processing logic filters the CSI representation using a motion target indicator (MTI) filter. Processing logic computes a weighted historical CSI average based on historical wireless signals that include historical CSI data received over time. Processing logic then subtracts the weighted historical CSI average from the CSI representation to produce the filtered CSI representation.

At block 430, processing logic transforms the filtered CSI representation to Doppler time vectors, such as by applying a 1D FFT on the filtered CSI representations. At block 435, processing logic stacks the Doppler time vectors column-wise to produce a Doppler trace image. In some embodiments, the Doppler traced image is a two-dimensional Doppler trace image.

At block 440, processing logic inputs the Doppler trace image into Bayesian CNN 150. At block 445, processing logic determines whether the Bayesian CNN 150 produced a human activity prediction. For example, the Bayesian CNN 150 may output a probability distribution over possible outcomes (no presence, major motion, minor motion, jerk motion, etc.), which quantify how certain (or uncertain) the Bayesian CNN 150 is about its prediction.

If the Bayesian CNN 150 prediction did not indicate a human activity, processing logic branches to the “No” branch, whereupon at block 450 processing logic continues to monitor the wireless signals. If the Bayesian CNN 150 prediction indicates a human activity, processing logic branches to the “Yes” branch whereupon processing logic reports the human activity prediction at block 455.

FIG. 5 illustrates a diagrammatic representation of a machine in the example form of a computer system 500 within which a set of instructions, for causing the machine to perform any one or more of the methodologies discussed herein for wireless sensing activity predictions.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 500 may be representative of a server.

The exemplary computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In some embodiments, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute API managed service instructions 525, for performing the operations and steps discussed herein.

The data storage device 518 may include a machine-readable storage medium 528, on which is stored one or more sets of API managed service instructions 525 (e.g., software) embodying any one or more of the methodologies of functions described herein. The API managed service instructions 525 may also reside, completely or at least partially, within the main memory 504 or within the processing device 502 during execution thereof by the computer system 500; the main memory 504 and the processing device 502 also constituting machine-readable storage media. The API managed service instructions 525 may further be transmitted or received over a network 520 via the network interface device 508.

The machine-readable storage medium 528 may also be used to store instructions to perform a method for intelligently scheduling containers, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “capturing,” “producing,” “filtering,” “predicting,” “computing,” “subtracting,” “transforming,” “inputting,” “training,” “creating,” “adjusting,” “utilizing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
capturing one or more wireless signals in a geographic area, wherein each one of the one or more wireless signals comprises channel state information (CSI) data;
producing a channel state information (CSI) representation based on the CSI data, wherein the CSI representation indicates a plurality of channel responses corresponding to the one or more wireless signals;
filtering, by a processing device, the CSI representation to remove at least one of the plurality of channel responses that correspond to a stationary object within the geographic area, wherein the filtering produces a filtered CSI representation; and
predicting a presence of a moving object within the geographic area based on the filtered CSI representation.

2. The method of claim 1, wherein the filtering is performed using a motion target indicator (MTI) filter, the method further comprising:
computing a weighted historical CSI average based on historical wireless signals comprising historical CSI data received over time; and
subtracting the weighted historical CSI average from the CSI representation to produce the filtered CSI representation.

3. The method of claim 1, wherein the moving object is a human, the method further comprising:
transforming the filtered CSI representation into a Doppler trace image;
inputting the Doppler trace image into a Bayesian convolutional neural network (CNN) that is trained to detect one or more human activities; and
producing, by the processing device using the Bayesian CNN, a prediction that identifies at least one of the one or more human activities within the geographic area.

4. The method of claim 3, further comprising:
training the Bayesian CNN in a self-supervised training mode, wherein the training further comprises:
creating an augmented Doppler trace image from the Doppler trace image, wherein the augmented Doppler trace image is a deformable transform of the Doppler trace image relevant to one or more physical properties of the one or more wireless signals;
inputting the Doppler trace image and the augmented Doppler trace image into the Bayesian CNN, wherein the Bayesian CNN transforms the Doppler trace image and the augmented Doppler trace image into an original latent space representation and an augmented latent space representation, respectively;
computing a contrastive loss between the original latent space representation and the augmented latent space representation; and
adjusting one or more properties of the Bayesian CNN based on the contrastive loss.

5. The method of claim 4, wherein the augmented Doppler trace image is created from the Doppler trace image using at least one of random scale and noise augmentation, random puncturing and erasures augmentation, random cyclic shifts augmentation, or random time dilation and warping augmentation.

6. The method of claim 4, wherein the training further comprises:
inputting the original latent space representation and the augmented latent space representation into a probe to produce a probe classification, wherein the probe comprises both a focal loss function and an evidence lower bound (ELBO) loss function;
utilizing the probe classification and the contrastive loss to train the Bayesian CNN during a first training stage; and
utilizing the probe classification to train the Bayesian CNN during a second training stage.

7. The method of claim 6, wherein the probe classification comprises activity logits corresponding to at least one of the one or more human activities.

8. A system comprising:
a processing device; and
a memory to store instructions that, when executed by the processing device cause the processing device to:
capture one or more wireless signals in a geographic area, wherein each one of the one or more wireless signals comprises channel state information (CSI) data;
produce a channel state information (CSI) representation based on the CSI data, wherein the CSI representation indicates a plurality of channel responses corresponding to the one or more wireless signals;
filter the CSI representation to remove at least one of the plurality of channel responses that correspond to a stationary object within the geographic area, wherein the filtering produces a filtered CSI representation; and
predict a presence of a moving object within the geographic area based on the filtered CSI representation.

9. The system of claim 8, wherein the filter of the CSI representation is performed using a motion target indicator (MTI) filter, and wherein the processing device, responsive to executing the instructions, further causes the system to:
compute a weighted historical CSI average based on historical wireless signals comprising historical CSI data received over time; and
subtract the weighted historical CSI average from the CSI representation to produce the filtered CSI representation.

10. The system of claim 8, wherein the moving object is a human, and wherein the processing device, responsive to executing the instructions, further causes the system to:
transform the filtered CSI representation into a Doppler trace image;
input the Doppler trace image into a Bayesian convolutional neural network (CNN) that is trained to detect one or more human activities; and
produce, using the Bayesian CNN, a prediction that identifies at least one of the one or more human activities within the geographic area.

11. The system of claim 10, wherein the processing device, responsive to executing the instructions, further causes the system to:
train the Bayesian CNN in a self-supervised training mode, the system to:
create an augmented Doppler trace image from the Doppler trace image, wherein the augmented Doppler trace image is a deformable transform of the Doppler trace image relevant to one or more physical properties of the one or more wireless signals;
input the Doppler trace image and the augmented Doppler trace image into the Bayesian CNN, wherein the Bayesian CNN transforms the Doppler trace image and the augmented Doppler trace image into an original latent space representation and an augmented latent space representation, respectively;
compute a contrastive loss between the original latent space representation and the augmented latent space representation; and
adjust one or more properties of the Bayesian CNN based on the contrastive loss.

12. The system of claim 11, wherein the augmented Doppler trace image is created from the Doppler trace image using at least one of random scale and noise augmentation, random puncturing and erasures augmentation, random cyclic shifts augmentation, or random time dilation and warping augmentation.

13. The system of claim 11, wherein the processing device, responsive to executing the instructions, further causes the system to:
input the original latent space representation and the augmented latent space representation into a probe to produce a probe classification, wherein the probe comprises both a focal loss function and an evidence lower bound (ELBO) loss function;
utilize the probe classification and the contrastive loss to train the Bayesian CNN during a first training stage; and
utilize the probe classification to train the Bayesian CNN during a second training stage.

14. The system of claim 13, wherein the probe classification comprises activity logits corresponding to at least one of the one or more human activities.

15. A non-transitory computer readable medium, having instructions stored thereon which, when executed by a processing device, cause the processing device to:
capture one or more wireless signals in a geographic area, wherein each one of the one or more wireless signals comprises channel state information (CSI) data;
produce a channel state information (CSI) representation based on the CSI data, wherein the CSI representation indicates a plurality of channel responses corresponding to the one or more wireless signals;
filter, by the processing device, the CSI representation to remove at least one of the plurality of channel responses that correspond to a stationary object within the geographic area, wherein the filtering produces a filtered CSI representation; and
predict a presence of a moving object within the geographic area based on the filtered CSI representation.

16. The non-transitory computer readable medium of claim 15, wherein the filter of the CSI representation is performed using a motion target indicator (MTI) filter, and wherein the processing device is to:
compute a weighted historical CSI average based on historical wireless signals comprising historical CSI data received over time; and
subtract the weighted historical CSI average from the CSI representation to produce the filtered CSI representation.

17. The non-transitory computer readable medium of claim 15, wherein the moving object is a human, and wherein the processing device is to:
transform the filtered CSI representation into a Doppler trace image;
input the Doppler trace image into a Bayesian convolutional neural network (CNN) that is trained to detect one or more human activities; and
produce, using the Bayesian CNN, a prediction that identifies at least one of the one or more human activities within the geographic area.

18. The non-transitory computer readable medium of claim 17, wherein the processing device is to:
train the Bayesian CNN in a self-supervised training mode, the processing device to:
create an augmented Doppler trace image from the Doppler trace image, wherein the augmented Doppler trace image is a deformable transform of the Doppler trace image relevant to one or more physical properties of the one or more wireless signals;
input the Doppler trace image and the augmented Doppler trace image into the Bayesian CNN, wherein the Bayesian CNN transforms the Doppler trace image and the augmented Doppler trace image into an original latent space representation and an augmented latent space representation, respectively;
compute a contrastive loss between the original latent space representation and the augmented latent space representation; and
adjust one or more properties of the Bayesian CNN based on the contrastive loss.

19. The non-transitory computer readable medium of claim 18, wherein the augmented Doppler trace image is created from the Doppler trace image using at least one of random scale and noise augmentation, random puncturing and erasures augmentation, random cyclic shifts augmentation, or random time dilation and warping augmentation.

20. The non-transitory computer readable medium of claim 18, wherein the processing device is to:
input the original latent space representation and the augmented latent space representation into a probe to produce a probe classification, wherein the probe comprises both a focal loss function and an evidence lower bound (ELBO) loss function;
utilize the probe classification and the contrastive loss to train the Bayesian CNN during a first training stage; and
utilize the probe classification to train the Bayesian CNN during a second training stage.
